(19) United States
(12) Patent Application Publication
(10) Pub. No.: US 2025/0148268 A1
(43) Pub. Date: May 8, 2025

(54) APPARATUS AND METHOD FOR ANALYZING OSCILLATION FREQUENCY DATA BASED ON AN ARTIFICIAL INTELLIGENCE STRUCTURE

(71) Applicants: HYUNDAI MOTOR COMPANY, Seoul (KR); KIA CORPORATION, Seoul (KR); UNIST (ULSAN NATIONAL INSTITUTE OF SCIENCE AND TECHNOLOGY), Ulsan (KR)

(72) Inventors: Kyung Woo Lee, Hwaseong-si (KR); Dae Un Sung, Hwaseong-si (KR); Young Rock Chung, Hwaseong-si (KR); Yong Hyun Ryu, Hwaseong-si (KR); Seul Ki Lee, Ulsan (KR); Kwang Ryeol Park, Ulsan (KR)

(73) Assignees: HYUNDAI MOTOR COMPANY, Seoul (KR); KIA CORPORATION, Seoul (KR); UNIST (ULSAN NATIONAL INSTITUTE OF SCIENCE AND TECHNOLOGY), Ulsan (KR)

(21) Appl. No.: 18/940,651

(22) Filed: Nov. 7, 2024

(30) Foreign Application Priority Data
Nov. 8, 2023 (KR) 10-2023-0153659
Aug. 30, 2024 (KR) 10-2024-0117989

(51) Int. Cl. G06N 3/0464; G06N 3/0455; G06T 3/4084; G06T 7/00

(52) U.S. Cl. CPC G06N 3/0464; G06N 3/0455; G06T 3/4084; G06T 7/0002; G06T 2207/20048; G06T 2207/20084; G06T 2207/30252

(57) ABSTRACT

An apparatus and method analyze oscillation frequency data based on an artificial intelligence structure including a fully connected network (FCN), which generates output data by being inserted into at least one of the encoder and the decoder and analyzing the relationship of all data. The apparatus includes a sensor unit configured to sense oscillation signals generated from a vehicle part in a time series manner by having a plurality sensors disposed thereon and includes a computing device configured to analyze oscillation frequency data based on sensing data provided from the plurality of sensors.

### CROSS-REFERENCE TO RELATED APPLICATIONS

The present application claims priority to Korean Patent Application No. 10-2023-0153659, filed on Nov. 8, 2023 and No. 10-2024-0117989, filed on Aug. 30, 2024, the entire contents of which are incorporated herein for all purposes by this reference.

### TECHNICAL FIELD

The present disclosure relates to an apparatus and method for analyzing oscillation frequency data, and more particularly, to an apparatus and method for analyzing oscillation frequency data based on artificial intelligence structure including a fully connected network (FCN) which generates output data by being inserted into at least one of the encoder and the decoder and analyzing the relationship of all data.

### BACKGROUND

Deep learning has improved its performance by solving various problems (i.e. vanishing problem, overfitting, etc.) of existing artificial neural networks by developing normalization and improving algorithms such as drop-out, and thanks to the advancement of hardware such as graphic processing unit (GPU) and the power of big data that can train complex structures, deep learning has recently shown excellent performance in many fields.

This deep learning technology is being developed rapidly by many overseas companies (Google, Facebook, Apple, Microsoft, Alibaba, Baidu) and is being applied to fields such as facial recognition, voice recognition, natural language processing, search services, and medicine. It is urgent to secure the latest technology in deep learning, which is developing rapidly, and to further preoccupy the application fields and quickly commercialize the fields.

The defect classification method used in conventional defect inspection equipment is shown in FIG. 1.

Algorithm developers extract features that are likely to be well classified from an image using an image processing algorithm, and then learn these features using a classifier (SVM, decision tree).

An optical device is constructed using lighting and a camera, and as the path of light changes in the defect area, the change in the amount of light entering the camera is converted into an image to increase the signal/noise ratio of the defect area. In these images, a defect detection algorithm detects defect candidates, and the defects are detected and classified using a feature extraction algorithm and a classification algorithm for the defect candidate images.

The performance of these methods has a limit depending on how well a person designs the feature extraction algorithm and extracts the features. In addition, the classification performance is limited depending on the selected characteristics, and the classification performance varies depending on the rotation of the image, the change of brightness, and the size change, etc. Since characteristics of the image are different for each product, it takes a lot of time in analysis and development.

Among the latest deep learning technologies, the classification algorithm that applies the CNN method is a method in which artificial intelligence extracts and learns features from images on its own. The above problem may be solved by applying deep learning technology to construct a defect classification algorithm. Among various deep learning structures, deep learning in the video field uses a structure called a convolutional neural network (CNN).

Image classification using CNN has the characteristic that the CNN itself extracts and learns features that can improve classification performance.

If these features are used and applied to the image-based defect detection field, significant performance improvements can be expected.

The configuration of a classifier using general deep learning is shown in FIG. 2.

After applying the convolution layer and activation function to the input image, the resulting feature map is reduced in size through a pooling layer and then passed to the next convolution layer. By repeatedly and deeply building up this basic structure, features for defect classification or fault diagnosis can be effectively extracted from images.

In the conventional fault diagnosis method, it was determined whether something is normal or abnormal based on the physical model of the part. However, there was a disadvantage that the driving state changed depending on various environmental conditions, making it difficult to find the corresponding physical model. Recently, a lot of research has been done on approaches based on data analysis methods such as machine learning based on collected data rather than physical models.

Specifically, fault characteristics have been extracted by sensing signals such as vibration, displacement, temperature, and ultrasonic waves generated from objects, then analyzing the effective value and variance for each frequency band through time series analysis through linear prediction coefficients, frequency analysis through fast Fourier transform, and discrete analysis based on these sensed values, and then classifying the results of testing and verifying the validity of these data through a multi-layer perceptron network.

However, the conventional method has a problem in that it has limitations in diagnosing the status and failure of parts whose characteristics vary over time because the conventional method extracts failure characteristics only using sensing signals according to time changes.

### SUMMARY

Various aspects of the present disclosure are directed to providing an apparatus and method for analyzing oscillation frequency data based on artificial intelligence structure that can process data without locality while borrowing the overall structure of U-Net.

Various aspects of the present disclosure are directed to providing an apparatus and method for analyzing oscillation frequency data based on artificial intelligence structure that can effectively operate on oscillation data in the frequency domain.

Various aspects of the present disclosure are directed to enable artificial intelligence to learn the relationship between data in low-frequency bands and data in high-frequency bands.

According to an embodiment of the present disclosure, there is provided an apparatus for analyzing oscillation frequency data based on an artificial intelligence structure, including: a sensor unit comprising at least one sensor configured to sense oscillation signals generated from a vehicle part in a vehicle in a time series manner; and a computing device configured to analyze oscillation frequency data based on sensing data provided from the plurality of sensors.

Here, the computing device may include: an input vector generation unit configured to receive the sensing data and generate a signal input vector by extracting signal amplitudes at predetermined sampling intervals from each of a plurality of predetermined sized windows by which the sensing data is sliced at predetermined intervals; a signal conversion unit configured to generate a frequency vector by converting the sensing data into frequency data by Fourier Transform; and an analysis unit configured to output state information by analyzing oscillation frequencies through a U-Net based deep learning model with the signal input vector provided from the input vector generation unit and the frequency vector provided from the signal conversion unit.

Here, the analysis unit may include: a data conversion unit configured to convert the sensing data into image data; an encoder configured to reduce a dimension while increasing the number of channels to capture characteristics of the converted image data; a decoder configured to restore data by reducing the number of channels and increasing a dimension using only low-dimensional encoded information; and a fully connected network (FCN) configured to be inserted into at least one of the encoder and the decoder having a structure that is symmetrical to each other, analyze relationship between all data, and produce output data.

Here, the fully connected network (FCN) block may be applied only to a last part of the encoder.

Here, the fully connected network (FCN) block may be applied only to a beginning part of the decoder.

Here, the fully connected network (FCN) block may be applied to both the last part of the encoder and the beginning part of the decoder.

Here, the encoder may include: a convolution layer configured to process the image data through a filter to perform a convolution operation and reduce a size of a feature map as a result of the operation; and a pooling layer configured to reduce the size of the feature map by sub-sampling the output feature map.

Here, the pooling layer may reduce the size of the feature map using a max pooling scheme that extracts a maximum value in an area overlapping with the filter, and performs down-sampling.

Here, the decoder may include: an upscale convolution layer configured to increase a dimension of the feature map and reduce the number of channels; and a transposed convolution layer configured to increase the size of the feature map copied from the encoder through skip connection and output the feature map in a same size as that of the image data.

Here, the sensing data may be oscillation signals sensed from the vehicle's reducer and the vehicle's interior area.

Here, the sensing data may be 3-channel 1-dimensional data, and each channel may contain 1-dimensional data having a length of 2048.

According to an embodiment of the present disclosure, there is provided a method for analyzing oscillation frequency data based on an artificial intelligence structure, including: an operation of converting received sensing data into image data; an encoding operation of reducing a dimension while increasing the number of channels to capture characteristics of the converted image data; a decoding operation of restoring data by reducing the number of channels and increasing the dimension using only information encoded in low dimensions through the encoding operation; and an intermediate processing operation using a fully connected network (FCN) that generates output data by analyzing correlation of all data in at least one of the encoding operation and the decoding operation, which have structures that are symmetrical to each other.

Here, the intermediate processing operation using the FCN may be performed at a last part of the encoding operation.

Here, the intermediate processing operation using the FCN may be performed at a beginning part of the decoding operation.

Here, the intermediate processing operation using the FCN may be performed both at the last part of the encoding operation and at the beginning part of the decoding operation.

Here, the sensing data may be oscillation signals sensed from the vehicle's reducer and the vehicle's interior area.

Here, the sensing data may be 3-channel 1-dimensional data, and each channel may contain 1-dimensional data having a length of 2048.

Here, the intermediate processing operation may adopt the FCN in the U-net structure, which has a symmetrical structure, and also analyze information on data located at both ends such as a low frequency and a high frequency.

The apparatus and method for analyzing oscillation frequency data based on artificial intelligence structure according to the present disclosure allows artificial intelligence to learn the relationship between data in the low-frequency band and high-frequency band, so it is possible to process data without locality while borrowing the overall structure of U-Net, and operate effectively on oscillation data in the frequency domain.

### BRIEF DESCRIPTION OF THE DRAWINGS

FIG. 1 is a diagram for explaining a conventional defect classification method.

FIG. 2 is a diagram showing the configuration of a classifier using general deep learning.

FIG. 3 is a block diagram showing the schematic configuration of an apparatus and method for analyzing oscillation frequency data based on artificial intelligence structure according to the present disclosure.

FIGS. 4A and 4B are examples showing the processing status of a sensing signal according to the present disclosure.

FIG. 5 is a diagram specifically showing the analysis unit of FIG. 3.

FIG. 6 is a flowchart showing the progress of the artificial intelligence structure-based oscillation frequency data analysis method according to an embodiment of the present disclosure.

FIG. 7 is a flowchart showing the progress of the artificial intelligence structure-based oscillation frequency data analysis method according to another embodiment of the present disclosure.

FIG. 8 is a flowchart showing the progress of the artificial intelligence structure-based oscillation frequency data analysis method according to another embodiment of the present disclosure.

FIG. 9 is a graph showing the val-epoch-loss relationship according to an embodiment of an artificial intelligence structure-based oscillation frequency data analysis device according to the present disclosure.

### DETAILED DESCRIPTION OF ILLUSTRATIVE EMBODIMENTS

With respect to the embodiments of the present disclosure, specific structural and functional descriptions are merely illustrative for the purpose of explaining the embodiments of the present disclosure, and the embodiments of the present disclosure may be implemented in various forms and should not be construed as limited to the embodiments described in the present disclosure.

Since various modifications may be applied to the present disclosure and there may be various embodiments, specific embodiments will be illustrated in the drawings and described in the present disclosure. However, this is not intended to limit the present disclosure to specific embodiments and should be understood to include all changes, equivalents or substitutes included in the spirit and technical scope of the present disclosure.

Terms including ordinal numbers such as “first” and “second” may be used to explain various components, but the components are not limited by the terms. The above terms are used only for the purpose of distinguishing one component from another. For example, a first component may be referred to as a second component without departing from the scope of the present disclosure, and similarly, the second component may be referred to as the first component.

When a component is referred to as “connected” or “linked” to another component, it may be directly connected to or linked to that another component, but it should also be understood that there may be further another component therebetween. On the other hand, when it is mentioned that a component is “directly linked” or “directly connected” to another component, it should be understood that there are no other components in between. Other expressions that describe the relationship between components, such as “between” and “immediately between” or “neighboring” and “directly adjacent to” should also be interpreted similarly.

The terms used in the present disclosure are used to explain a particular embodiment, and are not intended to limit the present disclosure. A singular term in the present disclosure includes a plural term unless it is contextually, clearly means a singular form. In the present disclosure, the terms such as “include” or “have” are to specify that there are features, numbers, steps, operations, components or parts described in the present disclosure, or combinations thereof, and It should be understood that the presence or the possibility of addition of numbers, steps, operations, components, part, or combinations thereof are not excluded in advance.

Unless defined differently, all the terms used here, including technical or scientific terms, have the same meaning as commonly understood by those who have normal knowledge in the technical field to which the present disclosure belongs. Terms such as what are commonly used in the dictionary should be interpreted as having the meaning of the context of the relevant technology, and are not interpreted as an ideal or excessively formal meaning unless defined clearly in the present disclosure.

Meanwhile, if an embodiment can be implemented differently, functions or operations specified within a specific block may occur differently from the order specified in the flowchart. For example, two consecutive blocks may actually be performed substantially simultaneously, or the blocks may be performed in reverse depending on the function or operation involved.

Hereinafter, an apparatus and method for analyzing oscillation frequency data based on artificial intelligence structure according to the present disclosure will be described with reference to the attached drawings.

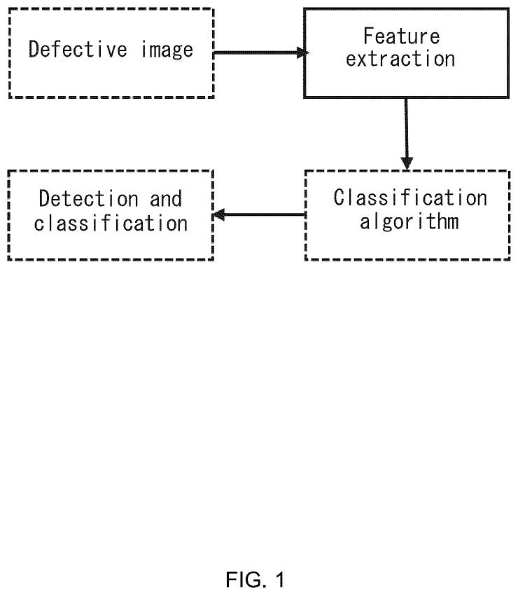

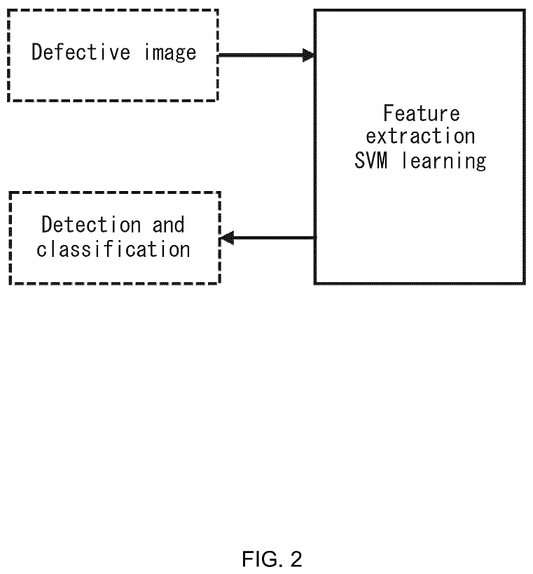

FIG. 1 is a block diagram showing the schematic configuration of an apparatus and method for analyzing oscillation frequency data based on artificial intelligence structure according to the present disclosure. As shown, a sensor unit 200 in which a plurality of sensors 200A, 200B, 200C, . . . , 200N that sense oscillation signals generated from a plurality of vehicle parts 100 in a time series manner are disposed, and a computing device 300 that analyzes oscillation frequency data based on sensing data provided from a plurality of sensors 200A, 200B, 200C, . . . , 200N of the sensor unit 200 are provided.

The computing device 300 includes an input vector generation unit 310, a signal conversion unit 320, and an analysis unit 330. The input vector generation unit 310, the signal conversion unit 320, and the analysis unit 330 may be implemented in software or hardware, respectively.

The input vector generation unit 310 receives sensing data about a part and generates a signal input vector. To this end, one or various sensors may be used to obtain the sensing data. Although this embodiment uses a vehicle component as the object for sensing and vibration data as the type of data in this description, it is merely an example and not limited to the specific case. For instance, the sensing data may be vibration, displacement, temperature, or ultrasonic data.

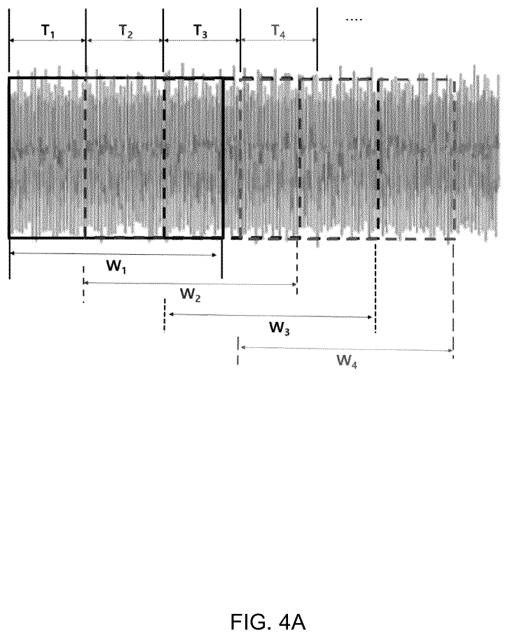

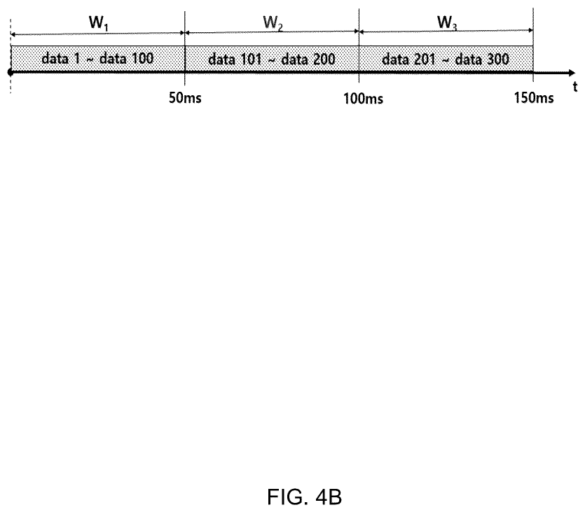

The input vector generation unit 310 receives sensing data for a part, slices the sensing data to predetermined window sizes (W1, W2, W3, W4, . . . ) at regular intervals(T1, T2, T3, T4, . . . ) as shown in FIG. 4A, and extracts signal amplitudes from each sliced window to generate a one-dimensional signal input vector to input into the analysis unit 330. For instance, as shown in FIG. 4B, the regular intervals may be constantly 50 ms, the window sizes constantly 100 ms, and the sampling interval for extracting amplitude data for each window 1 ms, and thus the corresponding input vector of each window may include 100 amplitudes.

The signal conversion unit 320 converts the received sensing data of the part in the time domain into the frequency domain and generates a frequency vector. The signal conversion unit 320 may output frequency data for the sensing data of the time domain by Fourier Transform. The frequency data may be input into the analysis unit 330 in a form of a one-dimensional vector.

The analysis unit 330 receives the signal input vector provided from the input vector generation unit 310 and the frequency vector provided from the signal conversion unit 320 and analyzes the oscillation frequency through a deep learning based model. The analysis unit 330 extracts a signal feature vector from the one-dimensional signal input vector through a Convolutional Neural Network (CNN), combines the extracted signal feature vector and the frequency vector to output a result of diagnosing a state of the part by analyzing the combined vector though a Deep Neural Network (DNN). In more detail, The analysis unit 330 may output the diagnosis result for the state by analyzing gradually low-resolution information from the combined vector including high-resolution information through a Pooling neural network and a Convolutional Neural Network (CNN) and analyzing the oscillation frequencies through a U-Net based deep learning model in a manner of combining high-resolution information obtained through Transposed CNNs and high-resolution information before passing the Pooling neural network and the Convolutional Neural Network (CNN).

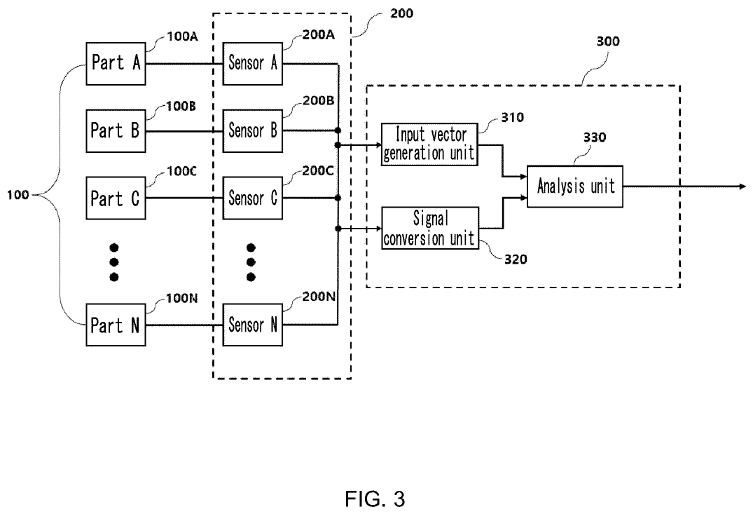

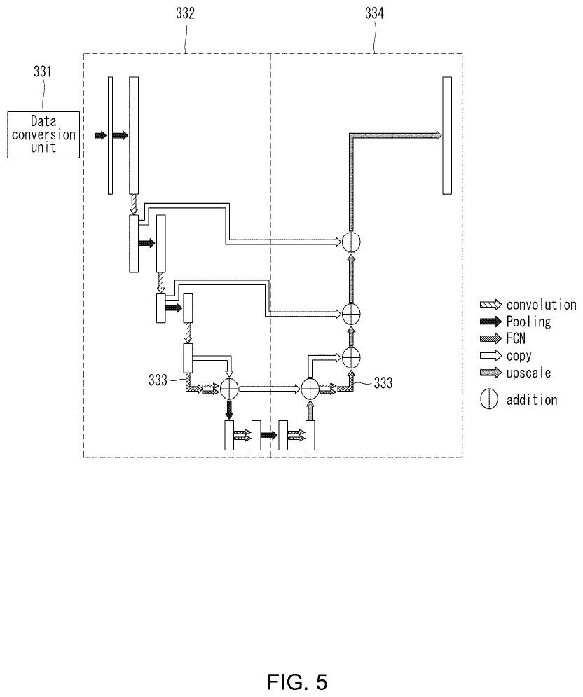

FIG. 5 is a diagram specifically showing the analysis unit of FIG. 3.

The analysis unit 330 includes a data conversion unit 331 that converts the sensing data into image data, an encoder 332 that reduces the dimension while increasing the number of channels to capture the characteristics of the converted image data, a decoder 334 that restores data by reducing the number of channels and increasing the dimension using only low-dimensional encoded information, and a fully connected network (FCN) block 333 that is inserted into at least one of the encoder 332 and decoder 334, which have a structure that is symmetrical to each other, and analyzes the relationship between all data to generate output data. As shown in FIG. 5, FCN may be introduced in both or one of the encoder 332 and the decoder 334.

Most of deep learning, which performs learning by discovering important patterns and rules from large-scale data, is being conducted through research based on a convolutional neural network (CNN).

The initial CNN model did not receive attention because it took a long time to process the high computational volume with the hardware performance at the time of development and did not show remarkable performance, but recently, with the advancement of hardware performance, it has been able to handle the high computational amount, which was a problem with the existing method, at high speeds and has shown a high level of performance, attracting the attention of many researchers, and active research is being conducted for various purposes.

In particular, since changing the convolution structure reflects the most direct impact on feature map extraction, most of the main research on CNN is conducted by changing the convolution structure.

The present disclosure borrows the overall structure of U-net, but adds FCN between the encoder and decoder for an artificial intelligence structure that can process data without locality.

The encoder 332 includes a convolution layer that processes the image data through a filter and reduces the size of the feature map as a result of the operation; and a pooling layer that reduces the size of the feature map by sub-sampling the output feature map.

The pooling layer reduces the size of the feature map using a max pooling method that extracts the maximum value in the area overlapping with the filter and performs down-sampling.

The decoder 334 includes an upscale convolution layer that increases the dimension of the feature map and reduces the number of channels; and a transposed convolution layer that increases the size of the feature map copied from the encoder through skip connection and outputs the feature map in the same size as the image data.

Unlike CNN, FCN is an artificial intelligence technique that does not need to consider locality. When data of x1 to xN is given, the relationships between all data are analyzed to create output data. In other words, if the input is x1 to xN and the output is y1 to yM, FCN may be expressed in the following linear algebra as [Equation 1].

$$Y = WX + b \qquad ( Equation l )$$

Here, X is a vector of size N consisting of x1 to xN, b is a vector of size N consisting of b1˜bN which are bias terms, Y is a vector of size M consisting of y1 to yM, and W is a matrix of size MxN consisting of weight terms w11 to wMN. Here, W and b are values that are automatically adjusted as artificial intelligence learns data. If the formula is analyzed for y1, it may be expressed as Equation 2 below.

$${y}_{1} = {\sum }_{i = 1}^{N} ( {w}_{\{ 1 , i \}} ⋆ {x}_{i} ) + {b}_{1} \qquad ( Equation 2 )$$

As can be seen from the above formula, the output y1 reflects all data from x1 to xN, which is why FCN does not need to consider locality. According to the present disclosure, process data with little locality can be effectively processed even in a U-Net-like structure by inserting this FCN technique into the encoder and decoder parts of U-Net. U-Net, to which FCN has been applied, has an advantage that artificial intelligence can analyze relationships between data that are geographically separated, so in the case of frequency data, artificial intelligence can learn the relationship between data in low-frequency bands and high-frequency bands. The artificial intelligence structure-based oscillation frequency data analysis device according to the present disclosure can operate on 2D image data or higher-dimensional data by extending FCN to N-th dimension.

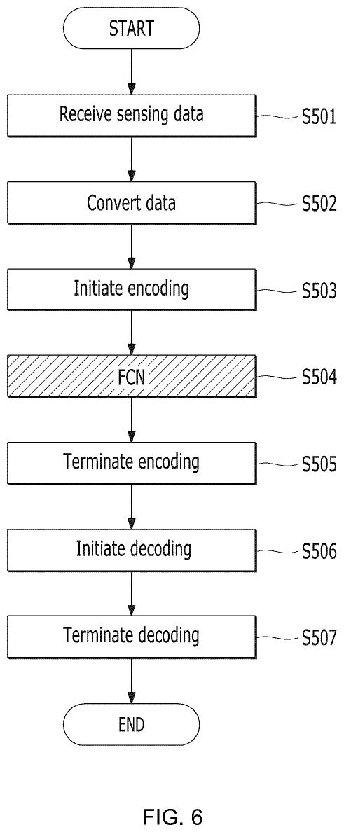

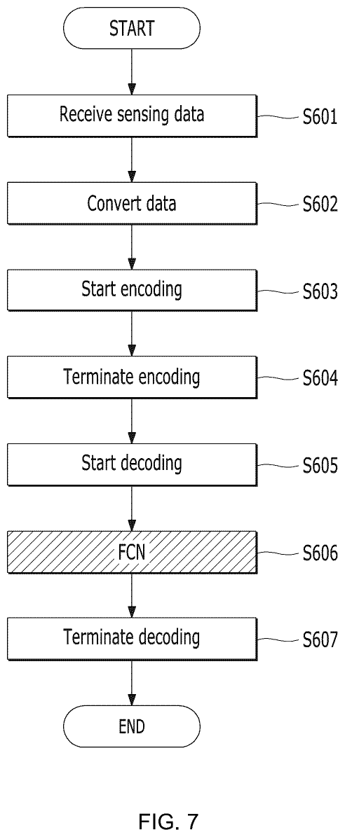

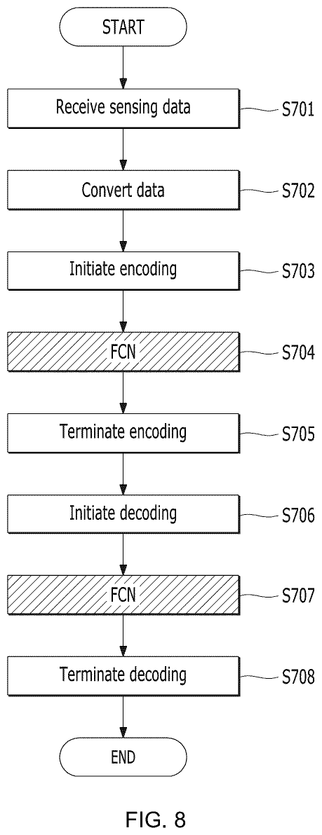

FIG. 6 is a flowchart showing the progress of the artificial intelligence structure-based oscillation frequency data analysis method according to an embodiment of the present disclosure, FIG. 7 is a flowchart showing the progress of the artificial intelligence structure-based oscillation frequency data analysis method according to another embodiment of the present disclosure, and FIG. 8 is a flowchart showing the progress of the artificial intelligence structure-based oscillation frequency data analysis method according to further another embodiment of the present disclosure.

Unlike other artificial intelligence techniques such as CNN or RNN, FCN requires a significant number of weight variables compared to the number of input and output data. In other words, there is a disadvantage that the size of the matrix W is quite large, unlike CNN and RNN series. However, in the present disclosure, the size of the data entering the FCN was reduced by inserting the FCN at the end of the encoder, the beginning of the decoder, or the end of the encoder or the beginning of the decoder. As a result, while reducing the number of FCN weight variables, the model as a whole has become a structure that can effectively process data with little locality.

As shown in FIG. 6, a plurality of sensors 200A to 200N disposed on each part sense oscillation signals generated from vehicle parts and transmit the sensed signals to the computing device 300. The input vector generation unit 310 and the signal conversion unit 320 of the computing device 300 receive sensing data in a time series manner (S501).

Sensing data are oscillation signals sensed from the vehicle's reducer and the vehicle's interior area. The sensing data is three-channel one-dimensional data, and each channel includes one-dimensional data having a length of 2048.

The analysis unit 330 receives an input vector provided from the input vector generation unit 310 and the signal conversion unit 320 and analyzes the oscillation frequency through a deep learning-based model based on artificial intelligence structure. The data conversion unit 331 of the analysis unit 330 converts the received sensing data into image data (S502).

The encoder 332 initiates an encoding operation to reduce the dimension while increasing the number of channels to capture the characteristics of the image data (S503).

At the last part of the encoder, the fully connected network (FCN) block 333 analyzes the relationships between all data to generate output data (S504).

When the FCN block 333 completes the operation, the encoder 330 exits the encoding operation while performing the final convolution (S505).

The decoder 334 initiates decoding to restore data by reducing the number of channels and increasing the dimension using only the information encoded in low dimension by the encoder (S506).

The decoder 334 ends decoding and learns the sensed image data (S507).

FIG. 7 shows an oscillation frequency data analysis method based on an artificial intelligence structure according to an embodiment in which the intermediate processing step using the fully connected network (FCN) is performed at the start of the decoding operation, that is, at the beginning of the decoding step (S606).

FIG. 8 shows a method for analyzing oscillation frequency data based on artificial intelligence structure according to an embodiment in which the intermediate processing operation using the fully connected network (FCN) is performed both in the last part of encoding before the encoding operation ends (S704) and in the beginning part after the decoding operation begins (S707).

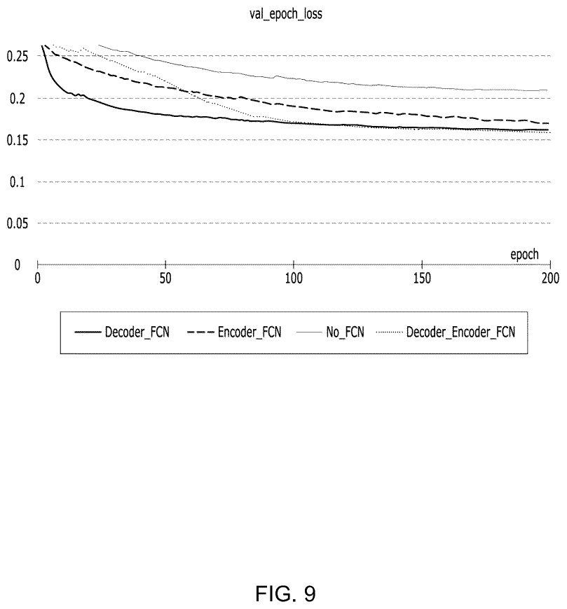

FIG. 9 is a graph showing the val-epoch-loss relationship according to an embodiment of an artificial intelligence structure-based oscillation frequency data analysis device according to the present disclosure. This shows the validation loss of oscillation frequency data depending on the presence and location of a fully connected network (FCN). The thick solid line (___) is a graph showing the change in loss as the number of times (epoch) of learning the entire dataset increases when FCN is introduced at the start of the decoder. The thick dotted line (--) is a graph showing the change in loss as the number of times (epoch) of learning the entire dataset increases when FCN is introduced at the last part of the encoder. On the other hand, when a fully connected network (FCN) is not applied to either the encoder or decoder, the loss value is the highest, as shown by the thin solid line (___), even if the number of times of learning increases. On the other hand, when it is performed both at the end of the encoding step and at the beginning of the decoding step, the loss value may have the lowest value as the number of times of learning increases, as shown by the thin dotted line (--). In other words, the oscillation frequency data may be analyzed better.

According to the present disclosure, by introducing FCN into both or one of the encoder and decoder of the artificial intelligence structure, it is possible to have an artificial intelligence structure that can effectively achieve better performance not only on data with strong local characteristics but also on data without such characteristics. U-Net, which consists only of existing CNNs, is not effective in analyzing the relationship between low and high frequencies in the case of oscillation frequency data, but the present disclosure, which borrows FCN from the U-Net structure, can also analyze information on data located at both ends, such as low and high frequencies, and thus U-Net-based artificial intelligence can analyze relationships between data at extreme positions.

Although the present disclosure has been described above with reference to specific embodiments, those having ordinary skill in the art will understand that various modifications and changes can be made to the present disclosure without departing from the spirit and scope of the present disclosure as set forth in the claims below.

What is claimed is:

1. An apparatus for analyzing oscillation frequency data based on an artificial intelligence structure, the apparatus comprising:
a sensor unit including at least one sensor configured to sense oscillation signals generated from a vehicle part in a vehicle in a time series manner; and
a computing device configured to analyze oscillation frequency data based on sensing data provided from the at least one sensor.

2. The apparatus of claim 1, wherein the computing device comprises:
an input vector generation unit configured to receive the sensing data and generate a signal input vector by extracting signal amplitudes at predetermined sampling intervals from each of a plurality of predetermined sized windows by which the sensing data is sliced at predetermined intervals;
a signal conversion unit configured to generate a frequency vector by converting the sensing data into frequency data by Fourier Transform; and
an analysis unit configured to output state information by analyzing oscillation frequencies through a U-Net based deep learning model with the signal input vector provided from the input vector generation unit and with the frequency vector provided from the signal conversion unit.

3. The apparatus of claim 2, wherein the analysis unit comprises:
a data conversion unit configured to convert the sensing data into image data;
an encoder configured to reduce a dimension while increasing a number of channels to capture characteristics of the image data;
a decoder configured to restore data by reducing the number of channels and increasing a dimension using only low-dimensional encoded information; and
a fully connected network (FCN) block configured to be inserted into at least one of the encoder and the decoder having structures that are symmetrical with each other, analyze a relationship between all data, and produce output data.

4. The apparatus of claim 3, wherein the FCN block is applied only to a last part of the encoder.

5. The apparatus of claim 3, wherein the FCN block is applied only to a beginning part of the decoder.

6. The apparatus of claim 3, wherein the FCN block is applied to both a last part of the encoder and a beginning part of the decoder.

7. The apparatus of claim 3, wherein the encoder comprises:
a convolution layer configured to process the image data through a filter to perform a convolution operation and reduce a size of a feature map as a result of the operation; and
a pooling layer configured to reduce the size of the feature map by sub-sampling an output feature map.

8. The apparatus of claim 7, wherein the pooling layer reduces the size of the feature map using a max pooling scheme that extracts a maximum value in an area overlapping with the filter and wherein the pooling layer performs down-sampling.

9. The apparatus of claim 3, wherein the decoder comprises:
an upscale convolution layer configured to increase a dimension of the feature map and reduce the number of channels; and
a transposed convolution layer configured to increase the size of the feature map copied from the encoder through a skip connection and output the feature map in a same size as that of the image data.

10. The apparatus of claim 1, wherein the sensing data are oscillation signals sensed from a reducer and an interior area of the vehicle.

11. The apparatus of claim 10, wherein the sensing data is 3-channel 1-dimensional data, and wherein each channel contains 1-dimensional data having a length of 2048.

12. A method for analyzing oscillation frequency data based on an artificial intelligence structure, the method comprising:
a converting operation of converting received sensing data into image data;
an encoding operation of reducing a dimension while increasing a number of channels to capture characteristics of the image data;
a decoding operation of restoring data by reducing the number of channels and increasing the dimension using only information encoded in low dimensions through the encoding operation; and
an intermediate processing operation using a fully connected network (FCN) that generates output data by analyzing correlation of all data in at least one of the encoding operation and the decoding operation, which have structures that are symmetrical with each other.

13. The method of claim 12, wherein the intermediate processing operation using the FCN is performed at a last part of the encoding operation.

14. The method of claim 12, wherein the intermediate processing operation using the FCN is performed at a beginning part of the decoding operation.

15. The method of claim 12, wherein the intermediate processing operation using the FCN is performed both at a last part of the encoding operation and at a beginning part of the decoding operation.

16. The method of claim 12, wherein the sensing data are oscillation signals sensed from a reducer and an interior area of the vehicle.

17. The method of claim 16, wherein the sensing data is 3-channel 1-dimensional data, and wherein each channel contains 1-dimensional data having a length of 2048.

18. The method of claim 12, wherein the intermediate processing operation adopts the FCN in a U-net based deep learning structure, which has a symmetrical structure, and wherein the intermediate process operation also analyzes information on data located at data extremes such as at a low frequency and at a high frequency.
